(19) United States
(12) Patent Application Publication
(10) Pub. No.: US 2001/0009586 A1
(43) Pub. Date: Jul. 26, 2001

(54) Electroacoustic transducer and method of manufacturing the same

(76) Inventor: Kazushi Suzuki, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/768,139

(22) Filed: Jan. 24, 2001

(30) Foreign Application Priority Data
Jan. 24, 2000 (JP) 2000-014920

(51) Int. Cl. H04R 25/00; H04R 1/02

(52) U.S. Cl. 381/151; 381/337; 381/339

(57) ABSTRACT

An electroacoustic transducer 1 comprises a base 24 made of a magnetic material, a magnetic core 22 erected on the base 24, a diaphragm 20 made of a magnetic material and spaced from the magnetic core 22, a magnet 25 constituting a magnetic circuit together with the base 24, the magnetic core 22, and the diaphragm 20 and supplying a static magnetic field, a coil 23 placed around the magnetic core 22 for supplying an oscillating magnetic field to the magnetic circuit, a support ring 26 for supporting the diaphragm 20, a lower housing 30 for accommodating such members, and an upper housing member 10 press-fitted over the entire periphery of the support ring 26.

### BACKGROUND OF THE INVENTION

1. Field of the Invention

The present invention relates to an electroacoustic transducer for generating sounds by electroacoustic transduction, and to a method of manufacturing the electroacoustic transducer.

2. Description of the Related Art

A electroacoustic transducer has a magnetic circuit in which a magnetic field applied from a magnet passes through a base member, a magnetic core and a diaphragm and then returns to the magnet. When an electrical vibration signal is supplied to a coil wound around the magnetic core, a vibrating magnetic field generated by the coil is superposed onto a static magnetic field of the magnetic field. Thus, vibrations of the diaphragm are transmitted to the air to generate sounds.

The sound generated at the rear surface side of the diaphragm is in opposite phase relation with a sound generated at the front surface side thereof. It is thus necessary to suppress the interference between the sound generated at the rear surface side of the diaphragm and the sound generated at the front surface side as much as possible. When the sealing of a space defined at the rear-surface side of the diaphragm is performed as a measure against the interference, the resonance frequency f0 of the diaphragm increases owing to an air damper effect. The smaller the transducer, the narrower the space defined at the rear-surface side of the diaphragm. Thus, the smaller the transducer, the larger the influence of the air damper effect. In order to decrease the increased resonance frequency f0, it is necessary to increase the mass of the diaphragm. Conversely, the level of the sound pressure is reduced when the mass of the diaphragm is increased.

There has been known a technique wherein a rear space of the diaphragm is opened to an external space to lessen the air damper effect, thus reducing the size of the transducer and increasing the sound pressure of the generated sounds. However, sounds are sometimes generated in a direction that differs from a desired direction, so that some products on each of which the transducer is mounted do not meet the specifications thereof. For example, in the case where an externally opened electroacoustic transducer is mounted on a portable phone or a personal handyphone system, sounds generated at the rear surface side of the diaphragm leak from an opening in a receiver. Thus, this transducer suffers from a drawback in that such sound leakage impedes phone conversations. Further, this transducer suffers from another drawback in that as a result of allowing the space defined at the rear surface side of the diaphragm to communicate with the external space, foreign substances may enter the inside thereof from the opening opened to the external space, and that such foreign substances adversely affect the reliability of components thereof.

Meanwhile, when a space defined at the front surface side of the diaphragm and the space defined at the rear surface side thereof communicate with each other through a gap between members, the interference between the sounds generated at the front surface side thereof and the sounds generated at the rear surface side thereof lowers the level of the sound pressure. Therefore, there is the necessity for sealing the gap between the members, especially, the gap through which the space defined at the front surface side communicates with the space-defined at the rear surface side of the transducer by using some means. Thus, it is considered as a measure against a reduction in the sound pressure to fix the members by adhesives and to seal the gap that permits such spaces to communicate with each other.

However, a size of the gap between the members varies with the positions of the members. That is, even when a certain gap is filled with a proper amount of an adhesive, such an amount of the adhesive may be insufficient for filling another gap, and excessive for filling still another gap. At worst, the adhesive may adhere to the diaphragm of the transducer. The manner in which the adhesive is filled in a gap largely depends on temperature, viscosity, and a drying time. Thus, this transducer has another drawback in that the control of the quality of the adhesive and the processes of applying and drying the adhesive is complex.

### SUMMARY OF THE INVENTION

The present invention has been made under the above circumstance, and therefore an object of the present invention is to provide a highly reliable, small-sized, and high-sound-pressure electroacoustic transducer and a method of manufacturing such an electroacoustic transducer.

To solve the above object, according to an aspect of the present invention, there is provided an electroacoustic transducer comprising: a base member made of a magnetic material; a magnetic core made of a magnetic material and erected on the base member; a diaphragm made of a magnetic material and spaced from an end of the magnetic core; a magnet for supplying a static magnetic field, the magnet constituting a magnetic circuit in cooperation with the base member, the magnetic core and the diaphragm; a coil disposed around the magnetic core for supplying an oscillating magnetic field to the magnetic circuit; a diaphragm supporting member adapted to support a peripheral portion of the diaphragm; and a housing member press-fitted over an entire periphery of the diaphragm supporting member.

According to this aspect of the present invention, when the housing member is attached to the diaphragm supporting member, the housing member is press-fitted over the entire periphery of the diaphragm supporting member. Thus, the gap between the housing member and the diaphragm supporting member is sealed. Consequently, the space formed at the front surface side of the diaphragm, which is surrounded by the housing member, the diaphragm supporting member, and the diaphragm, does not communicate with the space defined at the rear surface side of the diaphragm. Thus, the interference between the sound generated at the front surface side of the diaphragm and the sound generated at the rear surface side thereof can be reliably prevented. Consequently, the level of the sound pressure of the sound can be increased.

Moreover, sufficient connecting strength can be secured without adhesives by press-fitting the housing member into the diaphragm supporting member. Thus, the various drawbacks caused by using the adhesive can be eliminated. Meanwhile, there are two kinds of press-fitting methods that are available for press-fitting the housing member into the diaphragm supporting member. One is a “light press-fitting method”, by which a member is detachably press-fitted into another member. The other is what is called a “strong pressure fitting method”, by which a member is press-fitted into another member so that these members cannot be detached from each other. However, the light press-fitting method is preferable from the viewpoint of preventing the deformation of the members as much as possible. Further, although either of the internal surface and the outer surface of the diaphragm supporting member may be employed as a press fit surface, the outer surface having a sufficient size is preferable since the internal surface receives the diaphragm.

Further, when the diaphragm supporting member is constituted by a separate detachable member, it is preferable to employ a structure in which the housing member abuts against the top surface of the diaphragm supporting member and regulates the position of the diaphragm supporting member when attaching the housing member. Thus, the diaphragm supporting member can be prevented from floating and shifting the position thereof.

Incidentally, the diaphragm supporting member may employ the following three structures. That is, (a) a structure in which a diaphragm supporting member is mounted on another housing member, (b) a structure in which the magnet also serves as the diaphragm supporting member, and (c) a structure in which another housing member has a diaphragm supporting member integrally formed with.

According to another aspect of the present invention, there is provided an electroacoustic transducer comprising: a base member made of a magnetic material; a magnetic core made of a magnetic material and erected on the base member; a diaphragm made of a magnetic material and spaced from an end of the magnetic core; a magnet for supplying a static magnetic field, the magnet constituting a magnetic circuit in association with the base member, the magnetic core and the diaphragm; a coil disposed around the magnetic core for supplying an oscillating magnetic field to the magnetic circuit; a diaphragm supporting member adapted to support a peripheral portion of the diaphragm; a lower housing member provided with the diaphragm supporting member; and an upper housing member connected to the lower housing member; wherein the lower housing member and the upper housing member are welded together; and wherein a gap between the diaphragm supporting member and each of the housing members is sealed with weld beads.

According to this aspect of the present invention, when the lower housing member and the upper housing member are welded together, the sufficient connecting strength between both the housing members is secured. Additionally, the gap between the housing member and the diaphragm supporting member can be sealed with the weld beads by somewhat excessively applying welding energy so that the weld bead swells to the inner side of the housing member. This prevents the front-surface-side space from communicating with the rear-surface-side space through the gap outside the diaphragm supporting member. Thus, the interference between the sound generated at the front surface side of the diaphragm and the sound generated at the rear surface side thereof can be reliably prevented. Consequently, the level of the sound pressure of the sound can be increased.

Moreover, sufficient connecting strength can be secured without adhesives by welding the housing members. Thus, the various drawbacks caused by using the adhesive can be eliminated. Furthermore, although thermal welding and ultrasonic welding are available for welding the housing members, the ultrasonic welding, by which the swelling of the weld bead can be controlled with high accuracy, is preferable.

Incidentally, the diaphragm supporting member may employ the following three structures. That is, (a) a structure in which a diaphragm supporting member is mounted on another housing member, (b) a structure in which the magnet also serves as the diaphragm supporting member, and (c) a structure in which another housing member has a diaphragm supporting member integrally formed with.

According to still another aspect of the present invention, there is provided an electroacoustic transducer comprising: a base member made of a magnetic material; a magnetic core made of a magnetic material and erected on the base member; a diaphragm made of a magnetic material and spaced from an end of the magnetic core; a magnet for supplying a static magnetic field, the magnet constituting a magnetic circuit in association with the base member, the magnetic core and the diaphragm; a coil disposed around the magnetic core for supplying an oscillating magnetic field to the magnetic circuit; a diaphragm supporting member adapted to support a peripheral portion of the diaphragm; and a housing member adapted to form a side space outside the diaphragm supporting member; wherein a communicating portion is provided to make the side space communicate with a space provided at a rear surface side of the diaphragm.

According to this aspect of the present invention, the capacity of the rear-surface-side space defined at the rear-surface side of the diaphragm can be increased by devising the shape of the housing member to form the side space outside the diaphragm supporting member, and also devising the shapes of the base member, the magnet and the housing member to form the communicating portion for making the side space communicate with the rear-surface-side space. Thus, the air damper effect of the rear-surface-side space is reduced. Consequently, the resonance frequency f0 of the diaphragm can be restrained from rising. Moreover, the sound pressure of the generated sounds can be increased with decrease in weight of the diaphragm.

Incidentally, the diaphragm supporting member may employ the following three structures. That is, (a) a structure in which a diaphragm supporting member is mounted on another housing member, (b) a structure in which the magnet also serves as the diaphragm supporting member, and (c) a structure in which another housing member has a diaphragm supporting member integrally formed with.

According to yet still another aspect of the present invention, there is provided a method of manufacturing an electroacoustic transducer including: a base member made of a magnetic material; a magnetic core made of a magnetic material and erected on the base member; a diaphragm made of a magnetic material and spaced from an end of the magnetic core; a magnet for supplying a static magnetic field, the magnet constituting a magnetic circuit in association with the base member, the magnetic core and the diaphragm; a coil disposed around the magnetic core for supplying an oscillating magnetic field to the magnetic circuit; a diaphragm supporting member adapted to support a peripheral portion of the diaphragm; a lower housing member provided with the diaphragm supporting member; and an upper housing member connected to the lower housing member, the method comprising the steps of: welding the lower housing member and the upper housing member together by performing ultrasonic welding; and sealing a gap between the diaphragm supporting member and each of the housing members with weld beads.

According to this aspect of the present invention, when the lower housing member and the upper housing member are welded together, the sufficient connecting strength between both the housing members is secured. Additionally, the gap between the housing member and the diaphragm supporting member can be sealed with the weld beads by somewhat excessively applying welding energy so that the weld bead swells to the inner side of the housing member. This prevents the front-surface-side space from communicating with the rear-surface-side space through the gap outside the diaphragm supporting member. Thus, the interference between the sound generated at the front surface side of the diaphragm and the sound generated at the rear surface side thereof can be reliably prevented. Consequently, the level of the sound pressure of the sound can be increased.

Moreover, sufficient connecting strength can be secured without adhesives by welding the housing members. Thus, the various drawbacks caused by using the adhesive can be eliminated.

Incidentally, the diaphragm supporting member may employ the following three structures. That is, (a) a structure in which a diaphragm supporting member is mounted on another housing member, (b) a structure in which the magnet also serves as the diaphragm supporting member, and (c) a structure in which another housing member has a diaphragm supporting member integrally formed with.

Further, according to an embodiment of the manufacturing method of the present invention, when performing the ultrasonic welding, axial and torsional vibrations are applied to the connecting surface of each of the lower housing member and the upper housing member.

According to this embodiment of the present invention, the body of the transducer accommodates the magnetic circuit members, such as the diaphragm and the magnet. Thus, each of the connecting portions of the lower housing member and the upper housing member is shaped like a ring in such a way as to surround the magnetic circuit members. The modes of vibration in the case of ultrasonic welding are, for example, a lateral vibration mode in which the direction of vibration of the connecting portion is parallel to the connecting surface, a longitudinal vibration mode in which the direction of vibration of the connecting portion is perpendicular to the connecting surface, and a torsional vibration mode in which the connecting portion performs a circular motion in the connecting surface. Thus, it is preferable to weld the ring-like connecting portion in the torsional vibration mode. Consequently, the welding energy can be efficiently applied.

### BRIEF DESCRIPTION OF THE DRAWINGS

FIG. 1 is an exploded perspective view illustrating an embodiment of the present invention;

FIG. 2 is a perspective bottom view illustrating the upper housing;

FIG. 3A is a top plan view illustrating a state in which the upper housing is removed from the embodiment, and FIG. 3B is an end view taken along a line A-A of FIG. 3A and illustrates a state in which the upper housing is connected thereto;

FIG. 4 is an exploded end view illustrating the embodiment that is in the state shown in FIG. 3B;

FIG. 5A is an end view taken along a line B-B of FIG. 3A and illustrates the state in which the upper housing 10 is connected thereto, FIG. 5B is an end view taken along a line C-C of FIG. 3A and illustrates the state in which the upper housing 10 is connected thereto, and FIG. 5C is a partially enlarged view of a joint portion of the housing; and

FIG. 6 is a partially sectional view illustrating a state in which the electroacoustic transducer is mounted on an electronic device.

### DETAILED DESCRIPTION OF THE PREFERRED EMBODIMENTS

Now, a description will be given in more detail of preferred embodiments of the invention with reference to the accompanying drawings.

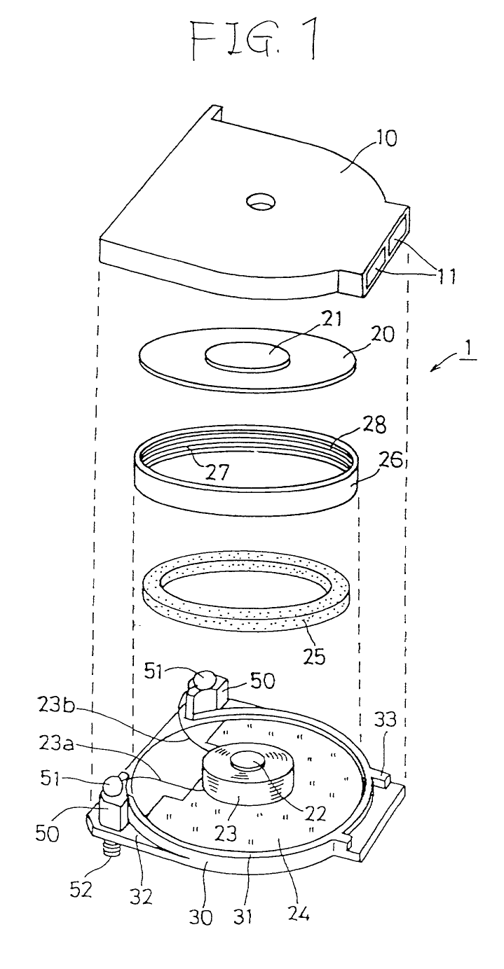

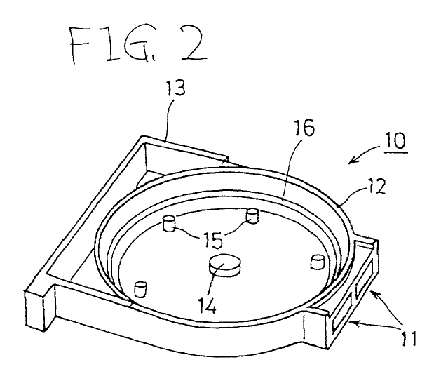

FIG. 1 is an exploded perspective view illustrating an embodiment of the present invention. FIG. 2 is a perspective bottom view illustrating an upper housing 10. An electroacoustic transducer 1 has a lower housing 30 on which a base 24, a magnetic core 22, a coil 23, a magnet 25, a support ring 26 and a diaphragm 20 are accommodated. Further, the transducer 1 is constructed by attaching an upper housing 10 to the lower housing 30. The entire transducer 1 is shaped nearly like a letter “D” in a planar form. The remainder of the transducer 1, apart from projecting portions, is approximately 11 mm wide, 10 mm long, and 3 mm high.

The lower housing 30 is made of a synthetic resin, such as a thermoplastic resin, and has a ring-like projecting portion 31, about ⅚ of the circumference of which are projected. Further, a nearly-D-shaped plate-like base 24 obtained by cutting a part of a disk is attached into the projecting portion 31. The cylindrical magnetic core 22 is erected at the center of the base 24. The coil 23 is wound around the magnetic core 22. The base 24 and the magnetic core 22 are made of a magnetic material. Both the base 24 and the magnetic core 22 may be integrally formed by, for example, press-fitting as a single pole piece member.

The magnet 25 is shaped like a ring, whose diameter is less than the inside diameter of the projecting portion 31. The magnet 25 is placed on the base 24 concentrically with respect to the magnetic core 22. An internal space is provided between the magnet 25 and the coil 23.

The support ring 26 is made of a non-magnetic material. The outside diameter of the support ring 26 is slightly less than the inside diameter of the projecting portion 31. The support ring 26 is disposed in such a manner as to be in contact with the base 24. A plurality of ring-like steps are formed in the inside surface of the support ring 26 including a protruding portion 27 and a support step 28. The rear surface of the protruding portion 27 abuts against the top surface and the outer surface of the magnet 25 to regulate the position of the magnet 25. Further, the support step 28 is formed in an upper portion of the protruding portion 27. The disk-like diaphragm 20 is horizontally put on this step 28 and thus positioned.

The diaphragm 20 is made of a magnetic material and supported by the step 28 of the support ring 26 at the peripheral portion thereof. A certain gap is secured between the center of the rear surface of the diaphragm 20 and the top end of the magnetic core 22. A disk-like magnetic piece 21 is fixed at the center of the front surface of the diaphragm 20 to thereby increase the mass of the diaphragm 20 and improve the vibration efficiency of the air.

The upper housing 10 is made of a synthetic resin, such as a thermoplastic resin. As shown in FIG. 2, the upper housing 10 has a ring-like projecting portion 12 and a box-like projecting portion 13. A certain space is formed in the inside of each of the projecting portions 12 and 13. Rectangular sound emitting holes 11 are formed in the peripheral portion on the side opposite to the projecting portion 13. A plurality of ring-like steps 16 are formed in the internal surface of the projecting portion 12. The diameter of the wall of the step 16 is slightly less than the outside diameter of the support ring 26. The step 16 is formed in such a manner as to have dimensions at which the wall of the step 16 can be lightly press-fitted over the entire periphery of the support ring 26. Further, the horizontal surface of the step 16 abuts against the top surface of the support ring 26 to thereby regulate the position of the support ring 26.

A plurality of protrusions 14 and 15 are formed on the ceiling surface of the upper housing 10. In a state in which the upper housing 10 is attached to the lower housing 30, the central protrusion 14 is placed at a fixed distance from the magnetic piece 21 of the diaphragm 20 and the six protrusions 15 are placed at a fixed distance from the diaphragm 20. These protrusions 14 and 15 serve to prevent the diaphragm from falling out or being deformed when a strong impact is given to the body of the transducer. Additionally, each of these protrusions 14 and 15 is formed in such a way as to have a height at which the normal vibration of the diaphragm 20 is hindered.

When the upper housing 10 is attached to the lower housing 30, the projecting portion 12 of the upper housing 10 lightly engages with the projecting portion 31 of the lower housing 30, so that the end surfaces of the projecting portions 12 and 31 serve as connecting surfaces. Further, the projecting portion 13 of the upper housing 10 abuts against the edge part of the rectangular portion 32 of the lower housing 30, so that the abutting surfaces of both the projecting portion 13 and the edge part serve as connecting surfaces. Moreover, the rear surface of the sound emitting hole portion 11 of the upper housing 10 abuts against short projecting portion 33 of the lower housing 30, so that the abutting surfaces of both the portions 11 and 33 serve as connecting surfaces.

Two terminal blocks 50 are respectively formed at the corners of the rectangular portions 32.

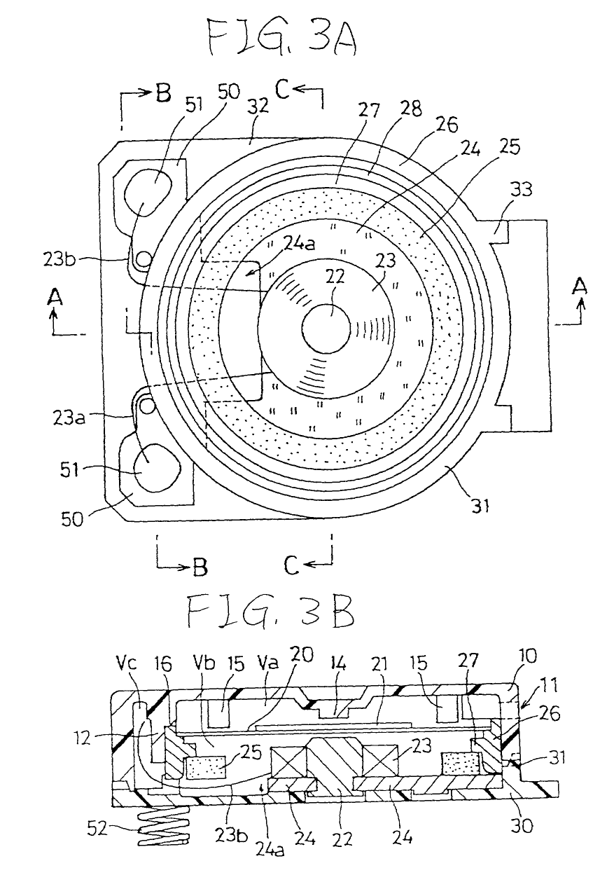

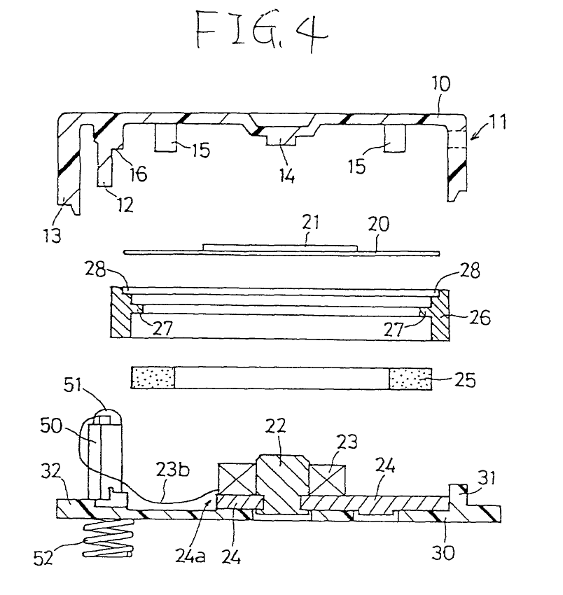

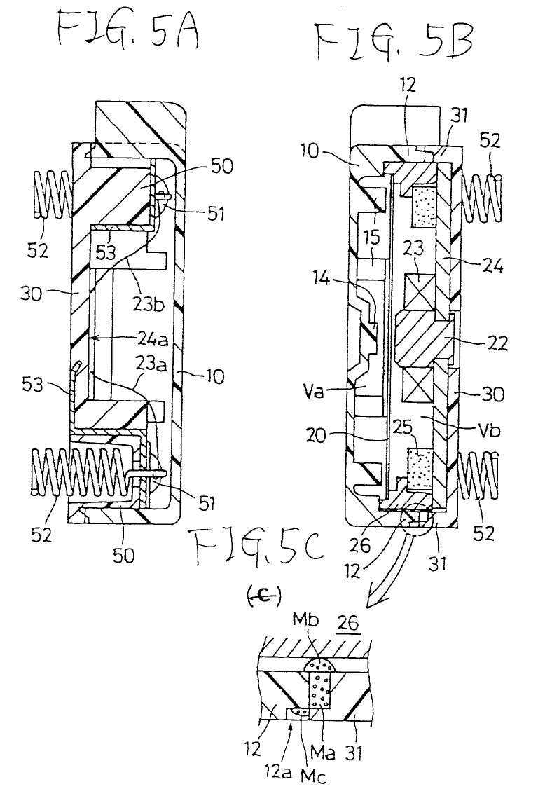

FIG. 3A is a top plan view illustrating a state in which the upper housing 10 is removed from the transducer 1. FIG. 3B is an end view taken along line A-A of FIG. 3A and illustrates a state in which the upper housing 10 is connected thereto. FIG. 4 is an exploded end view illustrating the embodiment that is in the state shown in FIG. 3B. FIG. 5A is an end view taken along a line B-B of FIG. 3A and illustrates the state in which the upper housing 10 is connected thereto. FIG. 5B is an end view taken along a line C-C of FIG. 3A and illustrates the state in which the upper housing 10 is connected thereto. FIG. 5C is a partially enlarged view of a joint portion of the housing.

Referring first to FIGS. 3A to 4, the coil 23 is wound around the central magnetic core 22. Further, the ring-like magnet 25 is placed coaxially with respect to the coil 23 with a gap in between. Apart of the base 24 is seen through the gap between the coil 23 and the magnet 25. The base 24 is shaped nearly like a letter “ID” in a planner form. A communicating portion 24a is formed by cutting a part of the base 24 at the terminal block side 50.

The communicating portion 24a provides a gap, whose height is equal to the thickness of the base 24, between the lower housing 30 and the magnet 25 and serves as a path through which the lead wires 23a and 23b of the coil 23 are drawn to the terminal blocks 50, and also serves as a path through which the side space Vc provided around each of the block 50 communicates with the rear-surface-side space Vb provided at the rear surface side of the diaphragm 20. The hermeticity of each of the rear-surface-side space Vb and the side space Vc is maintained by welding the housings together. Thus, the transducer 1 has a structure from which sounds generated at the rear surface side thereof are hard to leak to the external space. The provision of such a communicating portion 24a results in increase in acoustic capacity of the rear-surface-side space Vb provided at the rear surface side of the diaphragm 20. Consequently, the air damper effect of the rear surface side space Vb can be reduced.

The support ring 26 is put directly onto the base 24. The protruding portion 27 serves to regulate the top peripheral portion of the magnet 25. The step 28 of the support ring 26 supports the peripheral portion of the diaphragm 20. The positioning of each of the magnet 25 and the diaphragm 20 is performed by utilizing the shape of such a support ring 26. Thus, the magnetic coupling efficiency from the base 24 to the diaphragm 20 is increased.

The diaphragm 20 is supported at fixed distances respectively from the top end of the magnetic core 22 and the protrusions 14 and 15 of the upper housing 10. Thus, while the upward and downward vibrations are permitted, an excessive displacement of the diaphragm 20, which may cause the fallout and deformation thereof, is suppressed.

The step 16 of the upper housing 10 abuts against the top surface of the support ring 26 and serves to regulate the position of the support ring 26. The outer wall of the step 16 is lightly press-fitted over the entire periphery of the support ring 26. This connecting structure prevents the air leakage and the sound leakage between the front-surface-side space Va and the rear-surface-side space Vb without adhesives. Consequently, the interference between the sound generated at the front surface side of the diaphragm and the sound generated at the rear surface side thereof can be reliably prevented.

Referring next to FIG. 5A, each of the blocks 50 has a cavity portion opened to the bottom surface side of the lower housing 30. A coil-spring-like electrode 52 is attached into each of the cavity portions. A terminal plate 53 is partially embedded in each of the blocks 50 by insert molding. Thus, each of the terminal plates 53 is electrically connected to the corresponding electrode 52. Moreover, an exposed portion of each of the terminal plates 53 is electrically connected to a corresponding one of lead wires 23a and 23b of the coil 23 by solder 51. The lead wires 23a and 23b of the coil 23 are drawn out to the terminal plates 53 through the communicating portion 24a.

Referring next to FIG. 5B, the upper housing 10 is attached to the lower housing 30. Both the housings are set on the working bed of an ultrasonic welder in such a manner as to pinch both the housings by forces exerted from above and below. Then, axial and torsional vibrations are applied thereto. Thus, the connecting surfaces of the projecting portions 12 and 31 are melted. Thereafter, the melted portions are solidified by radiating heat. Consequently, the upper housing 10 and the lower housing 30 are welded.

As illustrated in FIG. 5C, weld beads Mb and Mc swell to the inner side and the outer side of the welded portion Ma at which both the projecting portions 12 and 31 are melted on the connecting surface therebetween. The weld bead Mb closely adheres onto the outer periphery of the support ring 26 and seals the gap between the support ring 26 and the upper housing 10 or the lower housing 30. Such a sealing structure can prevent the air leakage and the sound leakage between the front-surface-side space Va and the rear-surface-side space Vb. Consequently, the interference between the sound generated at the front surface side of the diaphragm and the sound generated at the rear surface side thereof can be reliably prevented.

A shallow groove 12a is formed in the entire periphery of the projecting portion 12 at the outer side of the connecting surface. Even when the weld bead Mc swells, the bead Mc goes in the groove 12a. This prevents the weld bead Mc from sticking out.

Next, the operation of the transducer 1 is described hereinbelow. The magnet 25 is magnetized in the direction of thickness thereof. For example, when the bottom surface of the magnet 25 is magnetized with a north pole, while the top surface thereof is magnetized with a south pole, a line of a magnetic force emanating from the bottom surface of the magnet 25 passes a path from the peripheral edge of the base 24 through the central portion of the base 24, the magnetic core 22, the central portion of the diaphragm 20, and the peripheral edge of the diaphragm 20, to the top surface of the magnet 25. Thus, as a whole, a closed magnetic circuit is constructed. The magnet 25 has a function of supplying a static magnetic filed to such a magnetic circuit. The diaphragm 20 is stably supported in a state in which the diaphragm 20 is attracted to the magnetic core 22 and the magnet 25.

The coil 23 wound around the magnetic core 22 supplies an oscillating magnetic field to the magnetic circuit when an electrical vibration signal is supplied from a circuit board thereto through the electrode 52 and the lead wires 23a and 23b. Then, the oscillating magnetic field is superposed on the static magnetic field, so that the diaphragm 20 is vibrated. Thus, the air at each of the top surface side and the bottom surface side of the diaphragm 20 are vibrated.

The space Va provided at the front surface side of the diaphragm 20 constitutes a resonance chamber. The oscillating frequency of the diaphragm 20 is nearly equal to the resonance frequency of the resonance chamber. Thus, sounds, the level of the sound pressure of which is high, are generated. The generated sounds are radiated from the sound emitting holes 11 of the upper housing 10 to the external space.

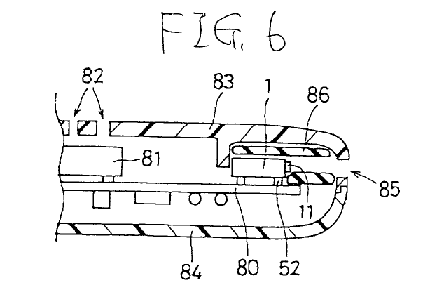

FIG. 6 is a partially sectional view illustrating a state in which the electroacoustic transducer 1 is mounted on an electronic device. Hereinafter, the case of employing a portable phone as the electronic device is described by way of example. Various kinds of electronic components are mounted on both sides of a circuit board 80, which is accommodated in casings 83 and 84.

A hollow gasket 86 made of a rubber material is attached to the electroacoustic transducer 1, which is entirely is put between the casing 83 and the circuit board 80. At that time, the coil-like electrode 52 is in elastic contact with the circuit board 80. This enables the electrical connection between the transducer 1 and the board 80. Consequently, a solder-free manufacture is realized. The gasket 86 has a function of making the sound emitting holes 11 communicate with an opening 85 opened to the external space. The hollow portion of the gasket 86 acts as the resonance chamber for the diaphragm 20.

The electroacoustic transducer 1 of the present invention is formed as of the sealed type that prevents rear-surface-side sounds, which are generated at the rear surface side of the diaphragm 20, from being radiated to the external space. Thus, even when a loudspeaker 81 is disposed in the vicinity of the electroacoustic transducer 1, the rear-surface-side sounds do not impede phone conversations. Moreover, the high density packaging of electronic components can be achieved.

Further, when the electroacoustic transducer 1 is constituted as of the closed type that has no rear-surface-side emitting holes, this eliminates the possibility that foreign substances enter the transducer 1 from the emitting holes. Moreover, this contributes the enhanced reliability of the components.

Incidentally, in the foregoing description, it has been described that the lower housing 30 is provided with the support ring 26 as a separate member for supporting the diaphragm 20. However, there can be provided different structures, for instance, a structure in which the magnet 25 also serves as the diaphragm supporting member, and a structure, in which the lower housing 30 and a portion for supporting the diaphragm 20 are integrally formed as a single member.

Furthermore, in the foregoing description, it has been described by way of example that the communicating portion 24a for making the side-surface-side space Vc communicate with the rear-surface-side space Vb is formed by partially cutting the base 24a. However, additionally, a communicating portion, which communicates with the space Vc, can be formed by forming a cutout or a through hole in the magnet 25, the support ring 26, or the lower housing 30.

As described above, the gap, through which the space provided at the front surface side of the diaphragm and the space provided at the rear surface side thereof communicate with each other, can be sealed by press-fitting the housing member and the diaphragm supporting member. Thus, the interference between a sound generated at the front surface side of the diaphragm and a sound generated at the rear surface side thereof can be prevented. Consequently, the level of the sound pressure of the sound can be increased.

Further, according to the present invention, when the lower housing member and the upper housing member are welded together, by sealing the gap between the housing member and the diaphragm supporting member with weld beads, the space provided at the front surface side of the diaphragm and the space provided at the rear surface side thereof do not communicate with each other. Consequently, the level of the sound pressure of the sound can be increased.

Moreover, according to the present invention, by forming a communicating portion, the space defined at the rear surface side of the diaphragm is enabled to communicate with a space defined at the side-surface side thereof. Thus, the air damper effect of the space defined at the rear surface side of the diaphragm is reduced. Consequently, the level of the sound pressure of the sound can be increased.

What is claimed is:

1. An electroacoustic transducer comprising:
a base member made of a magnetic material;
a magnetic core made of a magnetic material and erected on said base member;
a diaphragm made of a magnetic material and spaced from an end of said magnetic core;
a magnet for supplying a static magnetic field, said magnet constituting a magnetic circuit in cooperation with said base member, said magnetic core and said diaphragm;
a coil disposed around said magnetic core for supplying an oscillating magnetic field to said magnetic circuit;
a diaphragm supporting member adapted to support a peripheral portion of said diaphragm; and
a housing member press-fitted over an entire periphery of said diaphragm supporting member.

2. The electroacoustic transducer as claimed in claim 1, wherein said magnet also serves as said diaphragm supporting member.

3. An electroacoustic transducer comprising:
a base member made of a magnetic material;
a magnetic core made of a magnetic material and erected on said base member;
a diaphragm made of a magnetic material and spaced from an end of said magnetic core;
a magnet for supplying a static magnetic field, said magnet constituting a magnetic circuit in association with said base member, said magnetic core, and said diaphragm;
a coil disposed around said magnetic core for supplying an oscillating magnetic field to said magnetic circuit;
a diaphragm supporting member adapted to support a peripheral portion of said diaphragm;
a lower housing member provided with said diaphragm supporting member; and
an upper housing member connected to said lower housing member;
wherein said lower housing member and said upper housing member are welded together; and
wherein a gap between said diaphragm supporting member and each of said housing members is sealed with weld beads.

4. The electroacoustic transducer as claimed in claim 3, wherein said diaphragm supporting member is a separate member from said lower housing member.

5. The electroacoustic transducer as claimed in claim 3, wherein said diaphragm supporting member is integrally formed with said lower housing member.

6. An electroacoustic transducer comprising:
a base member made of a magnetic material;
a magnetic core made of a magnetic material and erected on said base member;
a diaphragm made of a magnetic material and spaced from an end of said magnetic core;
a magnet for supplying a static magnetic field, said magnet constituting a magnetic circuit in association with said base member, said magnetic core and said diaphragm;
a coil disposed around said magnetic core for supplying an oscillating magnetic field to said magnetic circuit;
a diaphragm supporting member adapted to support a peripheral portion of said diaphragm; and
a housing member adapted to form a side space outside said diaphragm supporting member;
wherein a communicating portion is provided to make said side space communicate with a space provided at a rear surface side of said diaphragm.

7. The electroacoustic transducer as claimed in claim 6 , wherein said magnet also serves as said diaphragm supporting member.

8. A method of manufacturing an electroacoustic transducer including: a base member made of a magnetic material; a magnetic core made of a magnetic material and erected on said base member; a diaphragm made of a magnetic material and spaced from an end of said magnetic core; a magnet for supplying a static magnetic field, said magnet constituting a magnetic circuit in association with said base member, said magnetic core and said diaphragm; a coil disposed around said magnetic core for supplying an oscillating magnetic field to said magnetic circuit; a diaphragm supporting member adapted to support a peripheral portion of said diaphragm; a lower housing member provided with said diaphragm supporting member; and an upper housing member connected to said lower housing member,
said method comprising the steps of:
welding said lower housing member and said upper housing member together by performing ultrasonic welding; and
sealing a gap between said diaphragm supporting member and each of said housing members with weld beads.

9. The method according to claim 8, wherein when performing the ultrasonic welding, axial and torsional vibrations are applied to a connecting surface of each of said lower housing member and said upper housing member.

10. The electroacoustic transducer as claimed in claim 8, wherein said magnet also serves as said diaphragm supporting member.
